(19) United States
(12) Patent Application Publication
(10) Pub. No.: US 2014/0333157 A1
(43) Pub. Date: Nov. 13, 2014

(54) PRESS FORMING MACHINE, PRESS FORMING METHOD USING PRESS FORMING MACHINE AND ROTOR CORE OF AC GENERATOR FOR AUTOMOBILES MANUFACTURED BY PRESS FORMING METHOD

(71) Applicants: Motoharu Nuka, Samutprakarn (JP); Takayo Noguchi, Konan-shi (JP); Tsuyoshi Muramatsu, Samutprakarn (JP)

(72) Inventors: Motoharu Nuka, Samutprakarn (JP); Takayo Noguchi, Konan-shi (JP); Tsuyoshi Muramatsu, Samutprakarn (JP)

(73) Assignee: SIGMA & HEARTS CO., LTD., Bangsaothong, Samutprakarn (TH)

(21) Appl. No.: 14/122,072

(22) PCT Filed: Aug. 9, 2013
(86) PCT No.: PCT/JP2013/071685

§ 371 Date: Nov. 25, 2013

(30) Foreign Application Priority Data
Aug. 9, 2012 (JP) 2012-177571

(51) Int. Cl. B21H 7/00; H02K 15/02; H02K 1/22; B21J 5/06

(52) U.S. Cl. CPC B21H 7/007; B21J 5/06; H02K 15/02; H02K 1/22
USPC 310/43; 72/210

(57) ABSTRACT

A taper shaped steel rod-like member allows a cold press molding apparatus to reduce burrs generated in tooling without the use of lubrication while also extending tool live. The method and process is characterized by holding the preshaped processed material on a backside tool, while press-contacting the processed material to a free rotation roll rotating toward the tip element on the processed material, and shaping a taper shape by plastic-reshaping of the processed material.

### TECHNICAL FIELD

The present invention relates to a cold-press molding apparatus and a cold-press molding method using the same, and further relates to a rotor core of an automobile alternating-current generator manufactured using the cold-press molding method thereof, wherein the cold-press molding apparatus can reduce burrs generated in between the backside tool without high grade lubrication films especially on molding a taper shape steel rod-like protruding material and can extend the life of the molding tool, and the cold-press molding method using the same; and further relates to a rotor core of an automobile alternating-current generator manufactured using the cold-press molding method.

### BACKGROUND

It is difficult to process a taper shape steel rod-like protruding material by direct extrusion because of requirement of high processing pressure. Accordingly, in general, a preshaped material processable using relatively low processing pressure is manufactured by such as cold forging in advance and then the material is processed to obtain a taper shape processed material by ironing in the axis direction.

FIG. 2 illustrates a rotor core 10 of an automobile alternating-current generator in which the taper shape pawl element is shaped, in which (a) is a cross section view of plane vertical to the axis of the rotor core 10, (b) is a vertical cross section view at a plane A-A passing the axis of the rotor core 10, and (c) is a side view of one of the pawl elements 11.

While such taper shape material, in general, is made by hot forging, warm forging or cold forging, it is problematic that abrasion of a mold is severe in warm forging and hot forging and stability of the shape is bad. Accordingly, in general, the shape is stabilized for use by a machine work after shaping. Further, a material having a long pawl element or an acicular shape end of the pawl element cannot be manufactured by using traditional method because of requirement of very high shaping pressure.

Further, it is possible to shape such long pawl element or an acicular shape end of the pawl element using direct cold-press forging, but it is problematic because of difficulty in requirement of very high pressure. Accordingly, an intermediate material is preshaped by such as cold forging and then the preshaped material thereof is processed to obtain a desired shape.

FIG. 3 is a view of the preshaped material preshaped by such as cold forging, in which (a) is a cross section view of vertical plane to an axis of the intermediate material, (b) is a vertical cross section view at a plane A-A passing the axis of the intermediate material, and (c) is a side view of one of pawl element equivalent of the intermediate material. Referring to Figure, the intermediate material 20 is preshaped by such as cold forging and the preshaped pawl element equivalent 21 is widened to an appropriate angle and then ironing is carried out to obtain the desired shape.

The important thing in such ironing processing is to prevent baking and galling between a tool and a processed material because it is a slide processing in which the ironing tool and the steel processed material contact directly under high pressure. Accordingly, high grade lubrication films such as phosphate films must be made on the surface of the processed material.

FIG. 4 is a diagram illustrating the relationship between a processed material on traditional slide-press processing and an ironing die, in which (a) illustrates positions and shapes of the processed material 31a and the backside tool (mandrel) 32 and the ironing die 33 before ironing shaping and (b) illustrates positions and shapes of the processed material 32b and the backside tool (mandrel) 32, and the ironing die 33 and a burr 34 after ironing shaping, wherein those are symmetrically arranged before and after ironing shaping.

Referring to Figure, 31a is a processed material before ironing shaping, 31b is a processed material after ironing shaping, 32 is a backside tool (mandrel), 33 is a ironing die and 34 is a burr occurred between the backside tool (mandrel) and the processed material.

As described above, as well as mandatorily better lubrication films on the surface of the processed material in the cold-press shaping by slide-press, and variation of quality should be minified.

Further, for example, as described in Patent Document 1, a means to lower the friction coefficient between the surface of the shaping tool and the processed material by coating the surface of the shaping tool with rigid films is required to extend the life of the shaping tool, e.g. an ironing tool.

### PRIOR ART

### Patent Document

Patent Document: Laid Open JP 2003-112229

### DESCRIPTION

### Objects to be Solved

However, there were the following problems in the traditional cold-press shaping method. (1) If variation of quality of lubrication films occurs, the pressure to the backside tool (mandrel) varies and variation of the backside shapes may be caused, and homogeneous lubrication films are mandatory, accordingly. (2) Further, in this method, it is problematic that the result due to variation of quality severely depends on the right-or-wrong quality of the lubrication films, and if unsatisfactory lubrication films are used, unsatisfactory shaping of the backside likely result from that the increased friction results in plastic flow of the processed material largely occurs due to frication holding and the burr occurred in between the backside tool (mandrel) should be large. (3) It is not avoidable that the burr in between the backside tool (mandrel) occurs somewhat because the ironing tool slides on the surface of the processed material under high pressure. Further, it is problematic that an effect on the life of the tool must be considered because a load should occur on the ironing tool as well.

Accordingly, the purpose of the present invention is to provide a cold-press molding apparatus that can reduce burrs generated in between the backside tool without high grade lubrication films on molding a taper shape steel rod-like protruding material, can carry out shaping of the backside tool in better way, and can extend the life of the molding tool; and
the cold-press molding method using the same; and
a rotor core of an automobile alternating-current generator manufactured using the cold-press molding method.

### Means to Solve the Objects

A cold-press molding apparatus of the present invention to make a taper shape steel rod-like protruding material and to achieve the above purposes is characterized by a preshaped processed material,
a backside tool holding the processed material thereon,
a free rotation roll freely rotating on the processed material held by the backside tool,
wherein a plastic reshaping of the processed material to shape a taper shape is conducted by rolling the free rotation roll toward the tip element while press-contacting the free rotation roll to the processed material.

In the above constitution, the preshaping of the processed material is preferably conducted by cold forging, warm or hot forging.

A cold press molding method of the present invention to make a taper shape steel rod-like protruding material and to achieve the above purposes is characterized by holding the processed material preshaped processed material on a backside tool, rolling the free rotation roll freely rolling toward the tip element while press-contacting on the processed material and shaping a taper shape by plastic-reshaping of the processed material.

In the above constitution, the preshaping of the processed material is preferably conducted by cold forging, warm or hot forging.

Further, the present invention to achieve the above purposes provides a rotor core manufactured by the above cold-press molding method and is characterized thereby.

### Effects of the Invention

As described above, according to the present invention, given holding the processed material preshaped processed material on a backside tool (mandrel), rolling the free rotation roll freely rolling toward the tip element while press-contacting to the processed material and shaping a taper shape by plastic-reshaping of the processed material, the shaping can be conducted at lower temperature because generated processing heat is transferred to the rotating roll, no high grade lubricant is required and further, an effect of variation of lubricants can be little.

In addition, since a maximum load on shaping is mostly linear load, load can be used more efficiently and further thermal expansion of the tool becomes less because temperature rising is suppressed by thermal transfer to the roll so that occurrence of burr on the pressed surface can be less and the shaping of the backside element can be conducted with sufficient precision. Further, the life of the shaping tool can be extended because the load on the shaping tool is less.

Further, given using the cold-press molding apparatus of the present invention, because the cold-press molding can be easily conducted according to the constitution thereof, a taper shape steel rod-like protruding material can be cold-press-molded without high grade lubrication films, with reducing burrs generated in between the backside tool and further with better shaping of the backside element, and the life of the apparatus per se can be extended as well.

Further, as for a rotor core (rotator) of an automobile alternating-current generator, the structure having long-pawl or a sharp angle tip, which is difficult to be made using the traditional shaping method, can be easily and effectively made at low cost.

### BRIEF DESCRIPTION OF THE DRAWINGS

FIG. 1 illustrates a view of a cold-press molding apparatus according to Embodiment of the present invention, in which (a) is a figure illustrating positions and shapes of a processed material and a backside tool (mandrel) and a free rotation roll before ironing and (b) is a figure illustrating positions and shapes of the processed material and the backside tool (mandrel), and the free rotation roll and a burr after ironing.

FIG. 2 illustrates a rotor core of an automobile alternating-current generator, in which (a) is a cross section view of plane vertical to the axis of the rotor core, (b) is a vertical cross section view at a plane A-A passing the axis of the rotor core, and (c) is a side view of one of the pawl elements.

FIG. 3 is the view of the preshaped intermediate material, in which (a) is a cross section view of vertical plane to an axis of the intermediate material, (b) is a vertical cross section view at a plane A-A passing the axis of the intermediate material, and (c) is a side view of one of pawl element equivalent of the intermediate material.

FIG. 4 is a diagram illustrating the relationship between a processed material on traditional slide-press processing and ironing die, in which (a) illustrates positions and shapes of the processed material and the backside tool (mandrel) and the ironing die before ironing shaping and (b) illustrates positions and shapes of the processed material and the backside tool (mandrel), and the ironing die and a burr after ironing shaping.

### EMBODIMENT

According to Embodiment of the present invention, referring to Figs., the inventors illustrates detail of a cold-press molding apparatus, a method of cold-press molding using the same, and a rotor core of an automobile alternating-current generator manufactured using the cold-press molding method thereof.

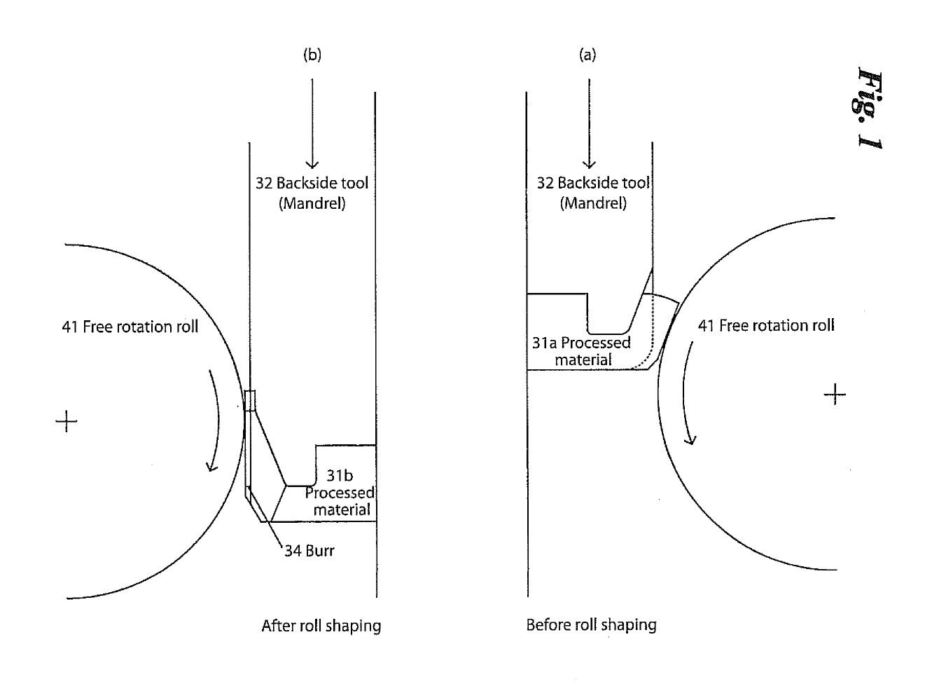

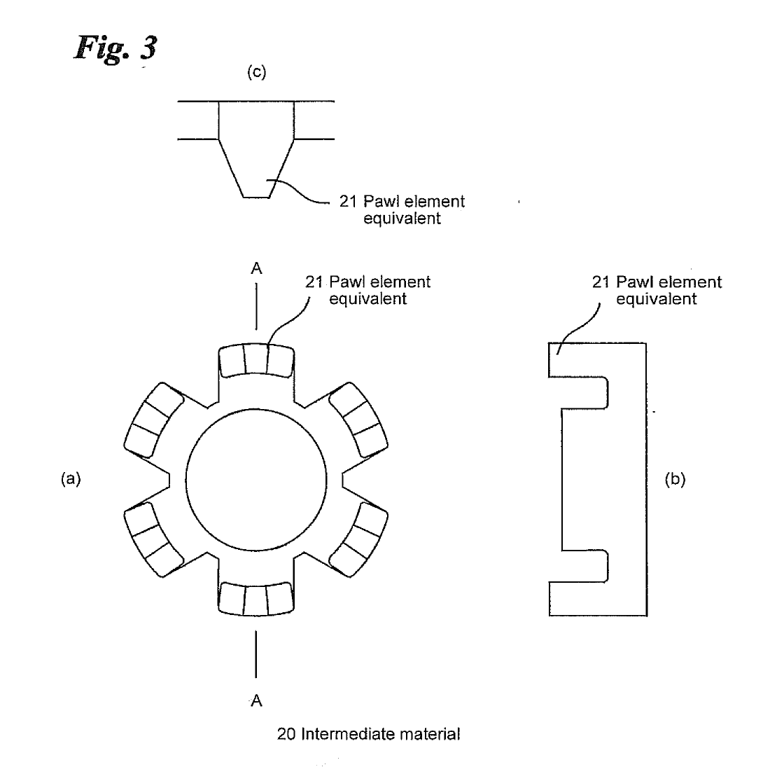

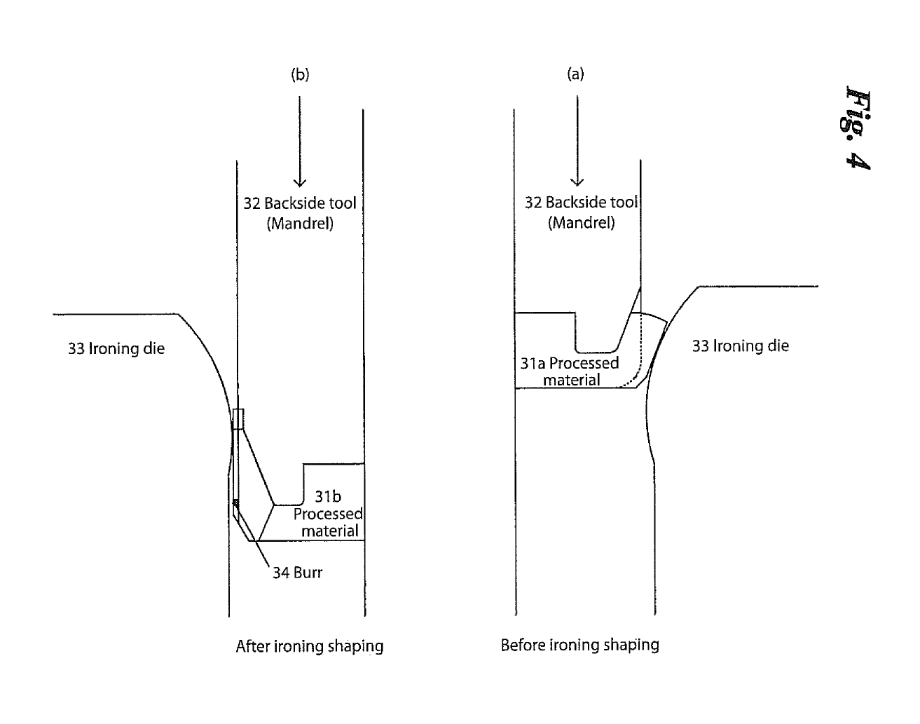

FIG. 1 illustrates a cold-press molding apparatus according to Embodiment of the present invention. Since the same contents as in FIG. 4 have the identical sign, an overlapped explanation is skipped, but according to the present Embodiment, the preshaped processed material 31 (31a, 31b) by cold forging shown in FIG. 3 is cold-press-molded by rolling press with the free rotation roll 41.

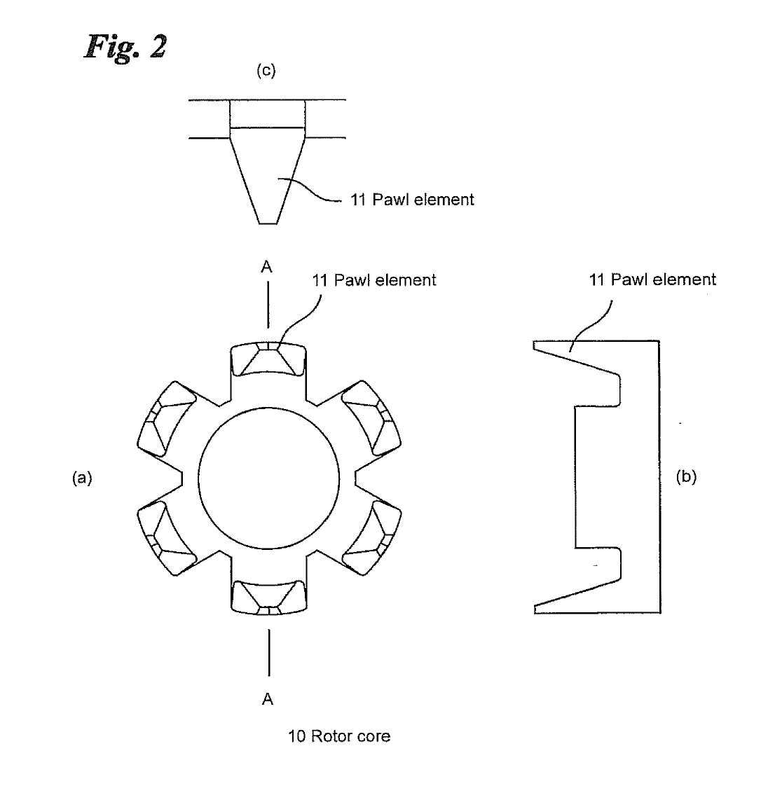

Specifically, on processed material 31 (31a, 31b) held by a backside tool (mandrel) 32, while a free rotation roll 41 freely rotating is being press-contacted, the free rotation roll 41 is rolled toward the taper shaped tip element of the pawl element 11, and the processed material 31 (31a, 31b) is plastic-reshaped by the rolling to shape the taper shape shown in FIG. 2. Accordingly, the rotor core 10 of an automobile alternating-current generator is made by shaping the taper shape pawl element.

According to such rolling press, as the free rotation roll 41 is contacting the surface of the processed material 31 (31a 31b) while rolling, almost no relative slide between the free rotation roll 41 and the processed material 31 exists, the relative friction is less and the processing temperature can be suppressed by heat transfer. Further, processing temperature can be controlled by adjusting e.g. the size and rotation rate of the free rotation roll 41 and cooling of the roll. Accordingly, a lubricant such as high grade phosphate film on the surface of the processed material 31 (31a, 31b) is not needed and further, an effect of variation of lubrication property of the lubricant is less.

Accordingly, because variation of pressure on the backside tool (mandrel) 32 becomes less, occurrence of variation of backside shape is less, and further less burr 34 occurs. Accordingly, it is easy to remove the burr 34 and the lesser burr 34 occurs, the lower material loss.

Further, the contact pressure load for the free rotation roll 41 is lesser than the ironing die therefor as a shaping tool so that the life of the free rotation roll 41 as a ironing tool can be longer than the ironing die.

As described above, slide between the free rotation roll 41 and the surface of the processed material 31 (31a, 31b) is almost none and the friction decreases so that the high grade metal hardening layer on the surface thereof is unnecessary to be installed. Further, accordingly, use of such as mechanical oil can be satisfactory on the surface of the processed material 31 (31a, 31b).

As described above, according to the present Embodiment, given holding the preshaped processed material on a backside tool (mandrel), rolling the free rotation roll toward the tip element while press-contacting the processed material and shaping a taper shape by plastic-reshaping of the processed material, no high grade lubricant is needed and further, an effect of variation of lubricants can be little. Further, the load is changed from surface load to linear load so that the transmission efficiency of the load can be improved.

A production of a rotor core of an automobile alternating-current generator, of which the structure has a long-pawl or a sharp angle tip, which is difficult to be made using the traditional shaping method, has become possible by using this method. Accordingly, the less burr on the pressed surface occurs so that the shaping of the backside element can be conducted with satisfactory precision. Further, the life of the shaping tool can be extended because the load on the shaping tool is less.

Further, according to the above Embodiment, preshaping of the processed material 31 is illustrated based on Embodiment of cold forging, but it is not limited and warm forging and hot forging can be used.

### Field of the Invention

Since the present invention comprising the above constituent can be implemented as described above so that taper shape steel rod-like protruding material can be relatively easily processed, and can be applied in a variety of productions of machines having complicated structure including a motor, a generator, an automobile, a vehicle, a combustion engine, a printing machine, a paper making machine, a yarn-making machine, and a loom.

### Reference of Sign

10 Rotor core

11 Pawl element

12 Intermediate material

13 Pawl element equivalent

14 Pulling apparatus

31, 31a, 31b Processed material

32 Backside tool (mandrel)

33 Ironing die

34 Burr

41 Free rotation roll

1.-5. (canceled)

6. A cold-press molding apparatus, to make a taper shape steel rod-like protruding material, comprising:
a backside tool holding a processed material thereon;
a free rotation roll freely rotatable relative to said processed material held by the backside tool;
wherein said processed material is plastic-reshaped to a taper shape by rolling said free rotation roll toward the tip element while press-contacting said processed material.

7. A cold-press apparatus, according to claim 6, wherein:
said processed material is formed by a group consisting of: a cold forging, a warm forging, and a hot forging.

8. A cold-press molding method, to make a taper shape steel rod-like protruding material, comprising the steps of:
holding the preshaped processed material on a backside tool and rolling a free rotation roll freely rotating on the processed material toward a tip element while press-contacting to plastic-reshape said processed material to form a taper shape.

9. A cold-press molding method for manufacturing a taper shape rod-like protruding material, comprising the steps of:
preshaping a processed material by a method selected from a group of methods consisting of: a cold forging, a warm forging, and a hot forging;
providing said preshaped processed material with a tip element portion thereof;
providing a backside tool and securing said preshaped processed material thereon;
providing a free rotation roll and freely rotating the same about a rotating axis relative to said backside tool and said preshaped processed material thereon such that said rotation roll is rolling in a direction order of first toward said backside tool and then to said next to said preshaped processed material;
contacting said rotation roll to said preshaped processed material during said free rotating while conducting a step of transitioning said backside tool along a tangential direction to said free rotation roll; and
plastic-reshaping to said tip element to said taper shape by rolling said free rotation roll toward said tip element while press-contacting said processed material thereby forming said taper shape rod-like protruding material.

10. A rotator core element manufactured by the process of claim 9.

11. A cold-press forming machine, comprising:
a free rotation roll rotatable about a rotating axis relative to said machine;
a backside tool movably secured to said cold-press forming machine proximate said free rotation roll;
a securing region on said back side tool operable to secure a protruding processed material thereon;
said securing region arranged on said back side tool in a downstream region relative to said free rotation roll;
said protruding processed material being secured to said securing region; and
means for operative movement of said backside tool along a tangential direction of said free rotation roll during a rotating use of said free rotation role and a contact with said free rotation roll, whereby during said operative movement said cold-press forming machine processes said processed material.
